(19) United States
(12) Patent Application Publication
(10) Pub. No.: US 2017/0314492 A1
(43) Pub. Date: Nov. 2, 2017

(54) DEVICE FOR PREVENTING SUDDEN ACCELERATION INCIDENT OF VEHICLE

(71) Applicant: Jin Min KIM, Seoul (KR)

(72) Inventor: Jin Min KIM, Seoul (KR)

(21) Appl. No.: 15/523,926

(22) PCT Filed: Oct. 28, 2015
(86) PCT No.: PCT/KR2015/011406

§ 371 Date: May 2, 2017

(30) Foreign Application Priority Data
Nov. 3, 2014 (KR) 10-2014-0150833
Nov. 26, 2014 (KR) 10-2014-0166396

(51) Int. Cl. F02D 41/22; B60K 28/14

(52) U.S. Cl. CPC F02D 41/22; B60K 28/14; F02D 2200/602; B60Y 2300/18025

(57) ABSTRACT

The present invention relates to a device for preventing a sudden acceleration incident, and to a device for preventing a sudden acceleration incident, electrically connected and provided between a fuel supply line and a starter of a vehicle. The device for preventing a sudden acceleration incident is not operated by means of an electromagnet, which is not operated, less than a set number of revolutions of a vehicle engine, since an electric current is not supplied due to the non-operation of a timer switch, which is provided between the fuel supply line and the starter. The fuel supply of the fuel supply line is cut off such that the device for preventing a sudden acceleration incident is operated by operating a permanent magnet of the polarity opposite to that of the electromagnet by means of the repulsive force of the electromagnet operated by the electric current, which is supplied by the operation of the timer switch, at the set number of revolutions of the vehicle engine, and the electromagnet is not operated since the electric current is not supplied by means of the operation of the timer switch if a certain time passes after the fuel supply of the fuel supply line is cut off. The supply of fuel is simply cut off so as to almost perfectly prevent a sudden acceleration incident, only if the number of revolutions, of the vehicle engine, unexpectedly causing a sudden acceleration is reached.

### TECHNICAL FIELD

The present invention relates to a device for preventing a sudden unintended acceleration incident of a vehicle and, more specifically, to a device for preventing a sudden unintended acceleration incident of a vehicle, which is installed on a fuel supply line of the vehicle, receives an electric current supplied by an ON operation of a current supplier according to a pre-configured number of revolutions of an engine, and cuts off, in response to such electric current supply, the fuel supply of the fuel supply line by a permanent magnet operated by a repulsive force generated by the operation of an electromagnet.

### BACKGROUND ART

Sudden unintended acceleration refers to a spontaneous forward or backward movement of a vehicle even without a driver's action of stepping on accelerator pedal or switching a gear. When a situation where a vehicle moves forward and backward by itself occurs, the vehicle may be damaged or a driver in the vehicle or a pedestrian walking near the sudden unintended acceleration vehicle may face a dangerous situation.

Although causes of such sudden unintended acceleration have not been clearly and completely established yet, a driver's error in operation, deterioration of and defects in vehicle components, etc. are assumed as the causes. In view of the deterioration of and defects in vehicle components among the above causes, it is assumed that deterioration of and defects in sensors for operating an Electronic Control Unit (ECU) and controlling air supplied to an engine may cause such sudden unintended acceleration. Specifically, the sudden unintended acceleration may be caused by, for example, deterioration of and defects in an intake Air Temperature Sensor (ATS), a Water Temperature Sensor (WTS), a Throttle Position Sensor (TPS), and an oxygen sensor. For example, when a Water Temperature Sensor (WTS) becomes obsolete or defective, the sensor may be unable to sense the water temperature and an Electronic Control Unit (ECU) having received information detected by the sensor determines the temperature of an engine as a lower temperature and thus ejects a large amount of fuel to raise the number of revolution of an engine up to 7000-8000 rpm, which may provide a cause of sudden unintended acceleration.

Therefore, there have been many attempts to prevent an incident caused by such sudden unintended acceleration of a vehicle. However, an obvious solution has not been found yet, and many devices for preventing a sudden unintended acceleration incident, which have been presented as a solution up to now, have not been proven to be perfect. Further, even devices showing relatively better performances require various parts, which inevitably require an expensive and complicated structure.

### RELATED PRIOR ARTS

(Patent Document 1) Korean Laid-Open Publication No. 10-2012-0017690

(Patent Document 2) Korean Registered Patent Publication No. 10-1449259

### DETAILED DESCRIPTION OF THE INVENTION

### Technical Problem

The present invention has been made in order to improve various problems as described above, and an aspect of the present invention is to provide a device for preventing a sudden unintended acceleration incident of a vehicle, which is installed between a starter and a fuel supply line of the vehicle and, when an electric current is supplied by an operation of a timer switch at a pre-configured number of engine revolutions of the vehicle, operates a permanent magnet through a repulsive force generated by the operation of an electromagnet installed in the fuel supply line, so as to cut off the fuel supply of the fuel supply line.

Another aspect of the present invention is to provide a device for preventing a sudden unintended acceleration incident of a vehicle, which includes a connection switch and a brake sensor connected between the timer switch and a controller to allow the device to operate only when a brake operates.

Another aspect of the present invention is to provide a device for preventing a sudden unintended acceleration incident of a vehicle, which includes a separate auxiliary timer switch connected between the starter and the fuel supply line so that, when the device does not operate even at a pre-configured number of revolutions of the vehicle, an electric current is supplied by the operation of the auxiliary timer switch to prevent the occurrence of a sudden acceleration incident.

Another aspect of the present invention is to provide a device for preventing a sudden unintended acceleration incident of a vehicle, which includes a connection jack connected between the starter and the timer switch so that, when the device mis-operates at a number of revolutions less than a pre-configured number of revolutions of the vehicle, the connection jack is released to block the supply of the electric current to prevent the operation of the device.

### Technical Solution

In order to achieve the aspects as described above, a device for preventing a sudden unintended acceleration incident according to the present invention, which is installed between and electrically connected to a fuel supply line and a starter of a vehicle and includes an electromagnet, a permanent magnet, and a timer switch installed between the fuel supply line and the starter, wherein the timer switch: does not operate at a number of engine revolutions smaller than a pre-configured number of engine revolutions of the vehicle, to block electric current supply to the electromagnet and thus prevent operation of the electromagnet, so as to prevent the device from operating; operates at the pre-configured number of engine revolutions of the vehicle, to allow the electric current supply to the electromagnet and thus enable the electromagnet to generate a repulsive force, which operates the permanent magnet having a polarity opposite to that of the electromagnet and thus operates the device to cut off the fuel supply of the fuel supply line; and, after passage of a predetermined time from the cutting off of the fuel supply of the fuel supply line, operates to block the electric current supply to the electromagnet and thus prevents the electromagnet from operating.

Further, it is recommended that the device further includes an auxiliary timer switch separately and electrically connected between the fuel supply line and the starter of the vehicle, wherein, when the timer switch does not operate to block electric current supply to the electromagnet and accordingly the device does not operate even at the pre-configured number of engine revolutions of the vehicle, the starter is turned off and the auxiliary timer switch operates to provide electric current supply to the electromagnet and thus operate the electromagnet, the repulsive force of which starts the permanent magnet to cut off the fuel supply of the fuel supply line, and the auxiliary timer switch operates, after passage of a predetermined time from the cutting off of the fuel supply of the fuel supply line, to block the electric current supply and thus prevent the electromagnet from operating.

Further, it is recommended that the device for preventing a sudden unintended acceleration incident includes: a connection body having a fuel inlet and a fuel outlet formed thereon, which are connected to the fuel supply line; the electromagnet installed on the outside of the connection body; the starter electrically connected to the electromagnet; the timer switch installed and connected in a connection path between the starter and the electromagnet; a controller which is installed and connected to the timer switch, senses the number of engine revolutions, and operates the timer switch; and a permanent magnet installed to face the electromagnet in the connection body and having a pole different from that of the electromagnet, wherein the permanent magnet moves forward and backward by repulsive force or magnetic force generated by on/off operations of the electromagnet, so as to open or close the fuel outlet of the fuel supply line.

Further, it is recommended that the device further includes: a connection switch installed on a connection path between the timer switch and the controller; and a brake sensor connected to the connection switch, wherein, only when a brake of a the vehicle operates, the brake sensor operates to connect the connection switch and thus transfer a signal of the controller to the timer switch.

Further, it is recommended that the device further includes: a connection switch separately connected in the connection path between the timer switch and the controller; and a brake sensor and another controller connected to the connection switch, wherein a signal of the controller is transferred to the timer switch at a number of engine revolutions equal to or higher than the pre-configured number of engine revolutions of the vehicle and, at a number of engine revolutions, which is smaller than the pre-configured number of engine revolutions but causes a sudden unintended acceleration, the brake sensor operates to connect the connection switch and thus transfer a signal of the another controller to the timer switch only when the brake operates.

Further, it is recommended that, when the timer switch operates to supply electric current and thus mis-operate the device at a number of revolutions smaller than the pre-configured number of engine revolutions of the vehicle, a connection jack electrically connected in the connection path between the timer switch and the starter is released to block the electric current supply to prevent the electromagnet from operating.

Further, it is recommended that the controller is an Electronic Control Unit (ECU) of the vehicle or a sensing sensor separately connected to a dashboard of the vehicle.

### Advantageous Effects

A device for preventing a sudden unintended acceleration incident of a vehicle according to the present invention can almost perfectly prevent a sudden unintended acceleration incident by simply cutting off the supply of fuel, only if the number of engine revolutions of the vehicle reaches the number of engine revolutions, unexpectedly causing a sudden unintended acceleration.

Further, the device has a simple structure and can thus be made cheaply. Therefore, anyone can easily buy and install the device.

Further, the device for preventing a sudden unintended acceleration incident of a vehicle includes a separate auxiliary timer switch connected between the starter and the fuel supply line. Therefore, when the device does not operate since an electric current is not supplied to the electromagnet, the device can supply the electric current, using the auxiliary timer switch, to operate the electromagnet.

The device can cope with all the various situations using a connection switch and a brake sensor, which are connected between the timer switch and the controller, or using another controller together with the connection switch and the brake sensor, thereby preventing a sudden unintended acceleration incident.

Furthermore, when the device for preventing a sudden unintended acceleration incident mis-operates, i.e., abnormally operates due to electric current supply to the timer switch, the electric current supply can be blocked by a connection jack connected between the starter and the timer switch to prevent the operation of the device.

### BRIEF DESCRIPTION OF THE DRAWINGS

FIG. 1 is a vertical cross-sectional view of a device for preventing a sudden unintended acceleration incident of a vehicle according to a first embodiment of the present invention before the device operates;

FIG. 2 is a vertical cross-sectional view of a device for preventing a sudden unintended acceleration incident of a vehicle according to a first embodiment of the present invention after the operation of the device starts;

FIG. 3 is a vertical cross-sectional view of a device for preventing a sudden unintended acceleration incident of a vehicle according to a second embodiment of the present invention before the device operates;

FIG. 4 is a vertical cross-sectional view of a device for preventing a sudden unintended acceleration incident of a vehicle according to the second embodiment of the present invention after the operation of the device starts;

FIG. 5 is a vertical cross-sectional view of a device for preventing a sudden unintended acceleration incident of a vehicle according to a third embodiment of the present invention before the device operates; and

FIG. 6 is a vertical cross-sectional view of a device for preventing a sudden unintended acceleration incident of a vehicle according to the third embodiment of the present invention after the operation of the device starts.

| | |
|---|---|
| 1: Fuel outlet | 2: Fuel inlet |
| 3: Permanent magnet | 4: Electromagnet |
| 5: Timer switch | 6, 6-1: Controller |
| 7: Connection jack | 8: Auxiliary timer switch |
| 9: Starter | 10: Connection body |
| 11: Connection switch | 12: Brake sensor |

### MODE FOR CARRYING OUT THE INVENTION

Hereinafter, preferred embodiments of a device for preventing a sudden unintended acceleration incident of a vehicle according to the present invention will be described in detail with reference to the accompanying drawings. The present invention is not limited to embodiments disclosed below but may be implemented in various forms. The present embodiments are provided only in order to completely disclose the present invention and completely inform a person skilled in the art of the category of the invention.

A sudden unintended acceleration incident occurs in a sudden unintended acceleration state. The sudden unintended acceleration state refers to an abnormal value of the number of revolutions (rpm) of an engine depending on to the type and use of the engine. Usually, sudden unintended acceleration occurs at an abnormal rpm of 4000 or more. Drivers have directly experienced incidents caused by such a sudden unintended acceleration assert that the sudden unintended acceleration is caused by a sudden radical increase of the number of engine revolutions due to either vehicles' defects or the drivers' errors.

Therefore, the device for preventing a sudden unintended acceleration incident of a vehicle according to the present invention is installed between a fuel supply line and a starter of the vehicle and operates a permanent magnet, which cuts off the supply of fuel using an electromagnet when a sudden unintended acceleration of the vehicle has occurred. In other words, the device operates the permanent magnet, which is attached to the electromagnet by magnetic force, using repulsive force generated by the operation of the electromagnet when an electric current is supplied by the operation of a timer switch, at the pre-configured number of engine revolutions of the vehicle, thereby cutting off the fuel supply of the fuel supply line.

The following is a detailed description of the configuration and operation of the above-mentioned device for preventing a sudden unintended acceleration incident of a vehicle of the present invention.

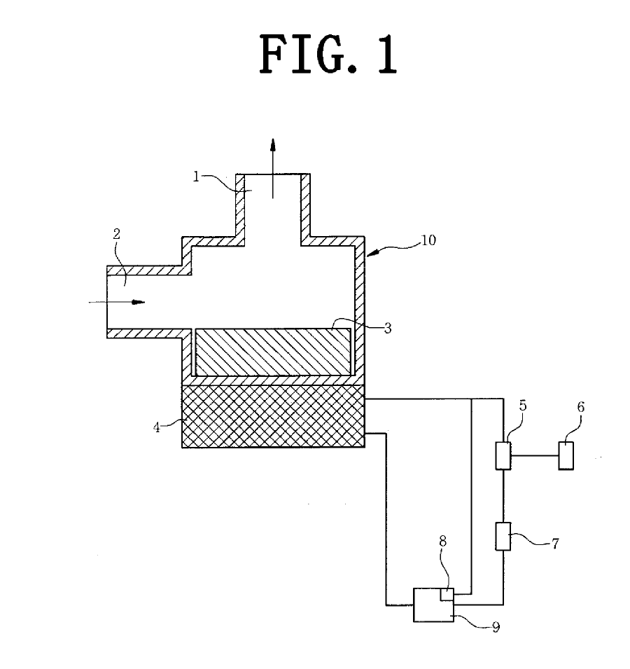

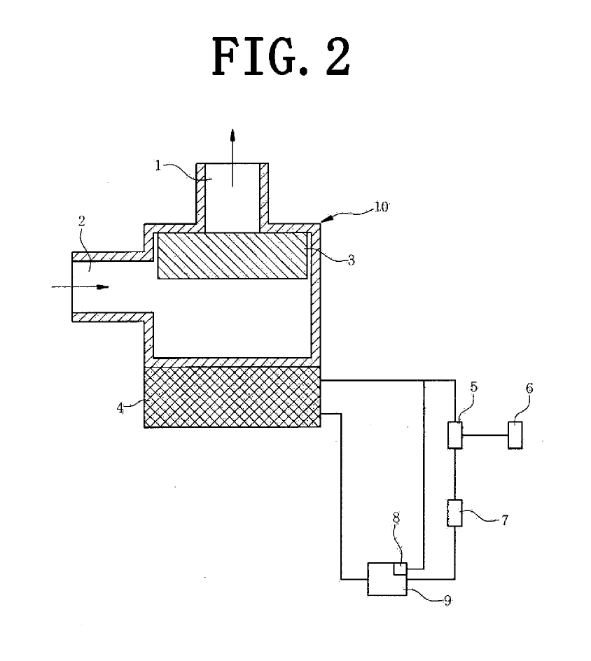

FIG. 1 is a vertical cross-sectional view of a device for preventing a sudden unintended acceleration incident of a vehicle according to a first embodiment of the present invention before the device operates, and FIG. 2 is a vertical cross-sectional view of a device for preventing a sudden unintended acceleration incident of a vehicle according to the first embodiment of the present invention after the operation of the device starts.

As illustrated in FIG. 1, the device for preventing a sudden unintended acceleration incident of a vehicle according to the present invention includes a connection body 10, an opening/closing means 3, an electromagnet 4, a starter 9, a timer switch 5, and a controller 6.

The connection body 10 has a shape of a rectangular box or a cylinder and is installed and connected in the path of a fuel supply line. The connection body has a fuel inlet 2 formed at one side surface thereof, a fuel outlet 1 formed at the front side thereof, and a permanent magnet 3 which is inserted in the connection body 10 and is placed on the inner rear surface of the connection body while facing the fuel outlet 1. Therefore, each of the fuel inlet 2 and the fuel outlet 1 is airtightly connected to the fuel supply line. It is recommended that the connection body 10 be made of a material, such as copper or stainless steel which is not affected by magnetic force of the electromagnet 4

The electromagnet 4 is installed to be in close contact with the outer side of the connection body 10 so as to face the permanent magnet 3. Since an electric current used by a vehicle is a direct current, the polarity of the electromagnet's side facing the permanent magnet 3 is always fixed as an N-pole or an S-pole. Therefore, when the electromagnet 4 operates, the permanent magnet 3 is detached therefrom by the repulsive force thereof and, when the electromagnet 4 does not operate, the permanent magnet 3 is attached thereto.

The starter 9 is a key box or a starting button by which an on/off state can be selected. One line of the starter is directly connected electrically to the electromagnet 4 and the other line thereof is connected to the electromagnet 4 together with the timer switch 5 and the controller 6.

The timer switch 5, which is installed and connected in the connection path between the starter 9 and the electromagnet 4, connects them to each other to allow electric current supply thereto under a predetermined condition and then disconnects them from each other after passage of a predetermined time.

The controller 6 is installed to be connected to the timer switch 5 and performs a control through a circuit configured so that the timer switch 5 operates under a predetermined condition, i.e., if the number of engine revolutions reaches the pre-configured number of engine revolutions at which sudden unintended acceleration occurs. As described above, after the passage of a predetermined time from the operation thereof, the timer switch 5 does not operate to block electric current supply. In other words, the controller 6 is configured to sense the number of engine revolutions of a vehicle, sets the number of engine revolutions equal to or higher than a predetermined the number of revolutions, causing a sudden unintended acceleration, and operates, when the controller 6 senses the number of engine revolutions, the timer switch 5 to supply an electric current, thereby operating the electromagnet 4. Since the number of engine revolutions, causing a sudden unintended acceleration, generally exceeds 4000 rpm, the pre-configured number of engine revolutions is required to have a value exceeding 4000 rpm. The number of engine revolutions is differently set according to the kind of an engine and the use of a vehicle. An Electronic Control Unit (ECU) preinstalled in a vehicle is used as the controller 6. The ECU senses the number of engine revolutions and controls the on/off operations of the timer switch 5. Regardless of the ECU, a separate sensing sensor, as the controller 6, may be installed in a vehicle and connected to a dashboard of the vehicle so as to sense the number of engine revolutions displayed on the dashboard and control on/off operations of the timer switch 5.

Further, a separate connection line is electrically configured between the electromagnet 4 and the starter 9 so that an auxiliary timer switch 8 is connected to the starter 9. Therefore, when the timer switch 5 does not operate even at the pre-configured number of revolutions, the controller controls, through a circuit configured in the starter 9, the auxiliary timer switch 8 to operate through the turn-off of the starter 9. Like the timer switch 5, the auxiliary timer switch 8 does not operate either after the passage of a predetermined time from the operation thereof to block electric current supply.

Meanwhile, a connection jack 7 is installed and connected in a connection path between the timer switch 5 and the starter 9. Therefore, when the device for preventing a sudden unintended acceleration incident mis-operates due to the operation of the electromagnet 4 by electric current supply to the electromagnet even at the number of engine revolutions which is less than the pre-configured number of revolutions, causing a sudden unintended acceleration, the controller arbitrarily releases the connection of the connection jack 7 to block the electric current supply and thus prevent the electromagnet 4 from operating, so as to prevent the operation of the device for preventing a sudden unintended acceleration incident.

Examining the above-configured operation of the device for preventing a sudden unintended acceleration incident according to the present invention, as illustrated in FIG. 1, when the starter 9 is in a key-on state or a starting motor thereof is operating at the number of engine revolutions less than the pre-configured number of engine revolutions, causing a sudden unintended acceleration of a vehicle, the timer switch 5 does not operate to block electric current supply to the electromagnet 4 and thus prevent the operation of the electromagnet 4. In this case, the permanent magnet 3 in the connection body 10 is attached to the electromagnet 4 by magnetic force and fuel is thus supplied through the fuel inlet 2 and the fuel outlet 1 of the connection body 10.

Thereafter, when the controller 6 senses the number of engine revolutions causing a sudden unintended acceleration of a vehicle, the timer switch 5 operates to supply electric current. When the electric current is supplied, as illustrated in FIG. 2, the permanent magnet 3, which has a polarity different from the electromagnet 4, is moved toward the fuel outlet 1 of the connection body 10 by the repulsive force generated by the operation of the electromagnet 4 and blocks the fuel outlet 1, thereby cutting off the supply of fuel. Here, after the operation of the device for preventing a sudden unintended acceleration incident, the electric current supply is blocked after the elapse of a predetermined time by the characteristics of the timer switch 5 as described above. Therefore, the electromagnet 4 does not operate and fuel is thus continuously supplied.

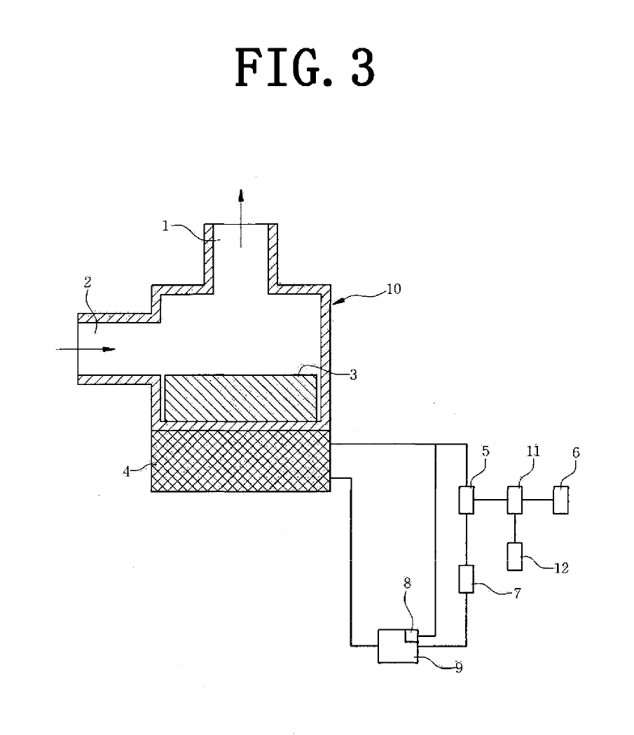

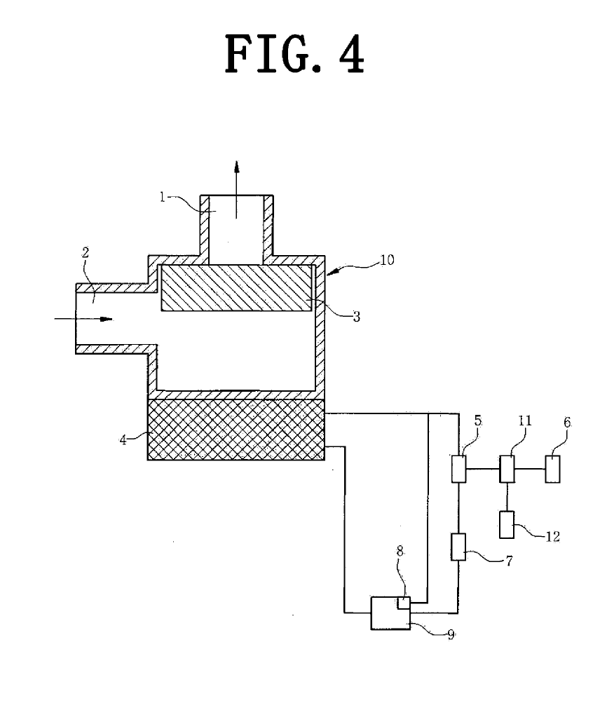

FIG. 3 is a vertical cross-sectional view of a device for preventing a sudden unintended acceleration incident of a vehicle according to a second embodiment of the present invention before the device operates, and FIG. 4 is a vertical cross-sectional view of a device for preventing a sudden unintended acceleration incident of a vehicle according to the second embodiment of the present invention after the operation of the device starts.

As illustrated in FIGS. 3 and 4, the device for preventing a sudden unintended acceleration incident of a vehicle according to the second embodiment of the present invention has a connection switch 11 installed on the connection path between the timer switch 5 and the controller 6, and a brake sensor 12 installed at the connection switch 11 in order to prevent the device for preventing a sudden unintended acceleration incident from operating even in a situation unintended by a driver.

The operation of the device for preventing a sudden unintended acceleration incident of a vehicle according to the second embodiment of the present invention will be described below.

As illustrated in FIG. 3, when the electromagnet 4 does not operate at normal times, the permanent magnet 3 is attached to the electromagnet 4 by magnetic force. Therefore, fuel is supplied through the fuel inlet 2 and the fuel outlet 1 of the connection body 10.

However, a pre-configured number of engine revolutions, causing a sudden unintended acceleration of a vehicle, may occur regardless of a driver's intention even when the sudden unintended acceleration does not occur. In this case, since the driver intends to continue driving, the supply of fuel should not be cut off.

Therefore, even when the number of engine revolutions of a vehicle reaches the pre-configured number of engine revolutions causing a sudden unintended acceleration, the device for preventing a sudden unintended acceleration incident of the present invention is controlled to operate only when a brake operates. In other words, provided that the brake does not operate when the number of engine revolutions of a vehicle reaches the pre-configured number of engine revolutions of the vehicle, causing a sudden unintended acceleration, the connection switch 11 is not connected although the controller 6 operates. Therefore, a signal of the controller 6 is not transferred to the timer switch 5.

As illustrated in FIG. 4, provided that a brake operates when the number of engine revolutions reaches the pre-configured number of engine revolutions of a vehicle, causing a sudden unintended acceleration, the brake sensor 12 connected to the brake senses the operation of the brake and makes the connection switch 11 be connected thereto. Therefore, a signal of the controller 6 is transferred to the timer switch 5 to operate the electromagnet 4. As a result, the permanent magnet 3 performs an operation of the device for preventing a sudden unintended acceleration incident, i.e., an operation of cutting off the supply of fuel, as described above, by means of the repulsive force generated by the operation of the electromagnet 4.

Since elements other than the connection switch 11 and the brake sensor 12 are identical to those of the device for preventing a sudden unintended acceleration incident of the above-described first embodiment, the same signs are assigned thereto.

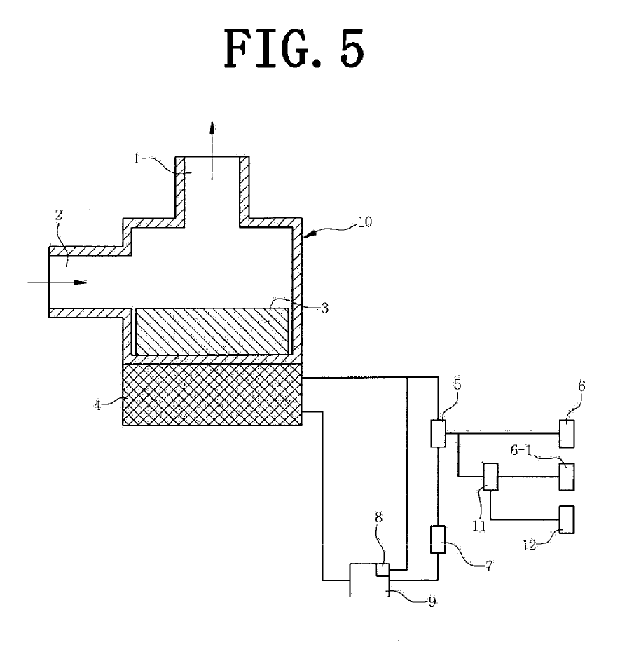

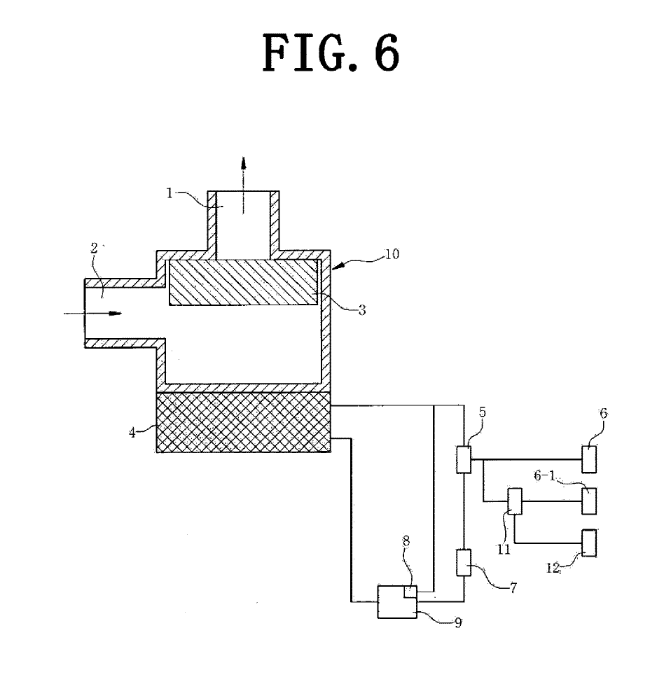

FIG. 5 is a vertical cross-sectional view of a device for preventing a sudden unintended acceleration incident of a vehicle according to a third embodiment of the present invention before the device operates, and FIG. 6 is a vertical cross-sectional view of a device for preventing a sudden unintended acceleration incident of a vehicle according to the third embodiment of the present invention after the operation of the device starts.

As illustrated in FIGS. 5 and 6, the device for preventing a sudden unintended acceleration incident of a vehicle according to the third embodiment of the present invention has a connection switch 11 installed on a connection line separately connected in the connection path between the timer switch 5 and the controller 6, and the brake sensor 12 and another controller 6-1 installed to be connected to the connection switch 11, in order to prevent the device for preventing a sudden unintended acceleration incident according to the present invention from operating even in a situation unintended by a driver as well as in order to prevent the device for preventing a sudden unintended acceleration incident from unconditionally operating when the number of engine revolutions reaches the pre-configured number of engine revolutions of a vehicle.

The operation of the device for preventing a sudden unintended acceleration incident of a vehicle according to the third embodiment of the present invention will be described below.

As illustrated in FIG. 5, normally, when the electromagnet 4 does not operate, the permanent magnet 3 is attached to the electromagnet 4 by magnetic force. Therefore, fuel is supplied through the fuel inlet 2 and the fuel outlet 1 of the connection body 10.

At a pre-configured number of engine revolutions causing a sudden unintended acceleration of a vehicle, a signal of the controller 6 is normally transferred to the timer switch 5 and the device for preventing a sudden unintended acceleration incident thus operates as in the above-described first embodiment. However, the pre-configured number of engine revolutions may occur regardless of the in a driver's intention even when the sudden unintended acceleration does not occur. In this case, since the driver intends to continue driving, the supply of fuel should not be cut off.

Therefore, when the number of engine revolutions of a vehicle has a very high value which is equal to or greater than a pre-configured number of engine revolutions causing a sudden unintended acceleration, the device for preventing a sudden unintended acceleration incident of the present invention normally operates. In addition, at a high number of engine revolutions which is less than the pre-configured number of engine revolutions but causes a sudden unintended acceleration, the device for preventing a sudden unintended acceleration incident of the present invention is controlled to operate only when a brake operates. In other words, at the high number of engine revolutions less than the pre-configured number of engine revolutions of a vehicle, causing a sudden unintended acceleration, unless the brake does not operate, the connection switch 11 is not connected although another controller 6-1 operates. Therefore, a signal of the another controller 6-1 is not transferred to the timer switch 5.

However, as illustrated in FIG. 6, provided that a brake operates when the number of engine revolutions has reached a high number of engine revolutions less than the pre-configured number of engine revolutions of a vehicle, causing a sudden unintended acceleration, the brake sensor 12 connected to the brake senses the operation of the brake and then makes the connection switch 11 be connected thereto. Therefore, a signal of the another controller 6-1 is transferred to the timer switch 5 and the electromagnet 4 thus operates. As a result, the permanent magnet 3 performs an operation of the device for preventing a sudden unintended acceleration incident, i.e., an operation of cutting off the supply of fuel, as described above, by means of the repulsive force generated by the operation of the electromagnet 4.

Since elements other than the another controller 6-1 are identical to those of the device for preventing a sudden unintended acceleration incident of the above-described first embodiment and second embodiment, the same signs are assigned thereto.

The device for preventing a sudden unintended acceleration incident of a vehicle according to the present invention has been described with reference to the accompanying drawings. However, the present invention is not limited to the embodiments and drawings disclosed in the present specification and it goes without saying that various changes in form and details may be made by a person skilled in the art within the scope of the technical idea of the present invention.

1. A device for preventing a sudden unintended acceleration incident, which is installed between and electrically connected to a fuel supply line and a starter of a vehicle and comprises an electromagnet, a permanent magnet, and a timer switch installed between the fuel supply line and the starter, wherein the timer switch: does not operate at a number of revolutions smaller than a pre-configured number of engine revolutions of the vehicle, to block electric current supply to the electromagnet and thus prevent operation of the electromagnet, so as to prevent the device from operating; operates at the pre-configured number of engine revolutions of the vehicle, to allow the electric current supply to the electromagnet and thus enable the electromagnet to generate a repulsive force, which operates the permanent magnet having a polarity opposite to that of the electromagnet and thus operates the device to cut off the fuel supply of the fuel supply line; and, after passage of a predetermined time from the cutting off of the fuel supply of the fuel supply line, operates to block the electric current supply to the electromagnet and thus prevents the electromagnet from operating.

2. The device of claim 1, further comprising an auxiliary timer switch separately and electrically connected between the fuel supply line and the starter of the vehicle, wherein, when the timer switch does not operate to block the electric current supply to the electromagnet and accordingly the device does not operate even at the pre-configured number of engine revolutions of the vehicle, the starter is turned off and the auxiliary timer switch operates to provide the electric current supply to the electromagnet and thus operate the electromagnet, the repulsive force of which starts the permanent magnet to cut off the fuel supply of the fuel supply line, and the auxiliary timer switch operates, after passage of a predetermined time from the cutting off of the fuel supply of the fuel supply line, to block the electric current supply and thus prevent the electromagnet from operating.

3. The device of claim 2, comprising:
a connection body having a fuel inlet and a fuel outlet formed thereon, which are connected to the fuel supply line;
the electromagnet installed on the outside of the connection body;
the starter electrically connected to the electromagnet;
the timer switch installed and connected in a connection path between the starter and the electromagnet;
a controller which is installed and connected to the timer switch, senses the number of engine revolutions, and operates the timer switch; and
a permanent magnet installed to face the electromagnet in the connection body and having a pole different from that of the electromagnet, wherein the permanent magnet moves forward and backward by repulsive force or magnetic force generated by on/off operations of the electromagnet, so as to open or close the fuel outlet of the fuel supply line.

4. The device of claim 3, further comprising:
a connection switch installed on a connection path between the timer switch and the controller; and a brake sensor connected to the connection switch, wherein, only when a brake of the vehicle operates, the brake sensor operates to connect the connection switch and thus transfer a signal of the controller to the timer switch.

5. The device of claim 3, further comprising:
a connection switch separately connected in the connection path between the timer switch and the controller; and a brake sensor and another controller connected to the connection switch, wherein a signal of the controller is transferred to the timer switch at a number of revolutions equal to or higher than the pre-configured number of engine revolutions of the vehicle and, at a number of revolutions, which is smaller than the pre-configured number of engine revolutions but causes a sudden unintended acceleration, the brake sensor operates to connect the connection switch and thus transfer a signal of the another controller to the timer switch only when the brake operates.

6. The device of claim 3, wherein, when the timer switch operates to supply electric current and thus mis-operates the device at a number of revolutions smaller than the pre-configured number of engine revolutions of the vehicle, a connection jack electrically connected in the connection path between the timer switch and the starter is released to block the electric current supply to prevent the electromagnet from operating.

7. The device of claim 3, wherein the controller is an Electronic Control Unit (ECU) of the vehicle.

8. The device of claim 3, wherein the controller is a sensor separately connected to a dashboard of the vehicle.
